(19) United States
(12) Patent Application Publication
(10) Pub. No.: US 2014/0247402 A1
(43) Pub. Date: Sep. 4, 2014

(54) In-cell Touch Control Panel

(71) Applicant: NOVATEK Microelectronics Corp., Hsin-Chu (TW)

(72) Inventors: Chun-Yi Chou, Hsinchu City (TW); Ching-Wu Tseng, New Taipei City (TW); Jiun-Jie Tsai, Hsinchu County (TW); Yu-Tsung Lu, Hsinchu County (TW); Tsen-Wei Chang, Taichung City (TW)

(73) Assignee: NOVATEK Microelectronics Corp., Hsin-Chu (TW)

(21) Appl. No.: 13/972,886

(22) Filed: Aug. 21, 2013

(30) Foreign Application Priority Data
Mar. 4, 2013 (TW) 102107514

(51) Int. Cl. G02F 1/1333

(52) U.S. Cl. CPC G02F 1/13338
USPC 349/12

(57) ABSTRACT

An in-cell touch control panel includes a liquid crystal layer; a top glass; a bottom glass; a plurality of driving electrodes, formed between the top glass and the liquid crystal layer; and a plurality of sensing electrodes, formed between the bottom glass and the liquid crystal layer, and perpendicular to the plurality of driving electrodes. The plurality of driving electrodes and the plurality of sensing electrodes are utilized for sensing a touch point on the in-cell touch control panel.

### BACKGROUND OF THE INVENTION

1. Field of the Invention

The present invention relates to an in-cell touch control panel, and more particularly, to an in-cell touch control panel in which a plurality of sensing electrodes and a plurality of driving electrodes are formed on a top glass and a bottom glass, respectively, so as to effectively separate the sensing electrodes and the driving electrodes by a liquid crystal layer for simplifying the process.

2. Description of the Prior Art

In general, the touch point positioning methods of conventional touch sensing devices utilize a time-domain scanning manner to transmit driving signals by driving electrodes and obtain sensing signals by sensing electrodes, and take a scanning sequence for positioning relative locations.

For example, in the current in-cell touch control panel, both the driving electrodes and the sensing electrodes are formed on a bottom glass for positioning touch points in order to reduce thickness and cost of a touch control panel.

However, since the driving electrodes and the sensing electrodes are both formed on the bottom glass in the conventional in-cell touch control panel, compared to structures of non-in-cell touch control panels, the conventional in-cell touch control panel requires more processes to isolate the driving electrodes and the sensing electrodes in order to reduce interactions between the driving electrodes and the sensing electrodes and prevent an impact on touch control determinations. Therefore, processes of the conventional in-cell touch control panel are much more complex, and the yield is not easy to control. Thus, there is a need for improvement of the prior art.

### SUMMARY OF THE INVENTION

It is therefore an objective of the present invention to provide an in-cell touch control panel in which sensing electrodes and driving electrodes are formed on a top glass and a bottom glass, respectively, so as to effectively isolate the driving electrodes and the sensing electrodes by a liquid crystal layer for simplifying the process.

The present invention discloses an in-cell touch control panel, comprising a liquid crystal layer; a top glass; a bottom glass; a plurality of driving electrodes, formed between the bottom glass and the liquid crystal layer; and a plurality of sensing electrodes, formed between the top glass and the liquid crystal layer, and substantially perpendicular to the plurality of driving electrodes; wherein the plurality of driving electrodes and the plurality of sensing electrodes are utilized for sensing a touch point on the in-cell touch control panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a structural diagram of an in-cell touch control panel according to an embodiment of the present invention.

FIG. 2A is a schematic diagram of a driving/common-voltage electrode layer shown in FIG. 1 according to an embodiment of the present invention.

FIG. 2B is a schematic diagram of a sensing electrode layer shown in FIG. 1 according to an embodiment of the present invention.

FIG. 2C is a perspective view of the sensing electrode layer and pixels in the in-cell touch control panel shown in FIG. 1 according to an embodiment of the present invention.

FIG. 2D is a perspective view of the sensing electrode layer and the driving/common-voltage electrode layer in the in-cell touch control panel shown in FIG. 1 according to an embodiment of the present invention.

FIG. 2E is a diagram of operations of the in-cell touch control panel shown in FIG. 1 according to an embodiment of the present invention.

### DETAILED DESCRIPTION

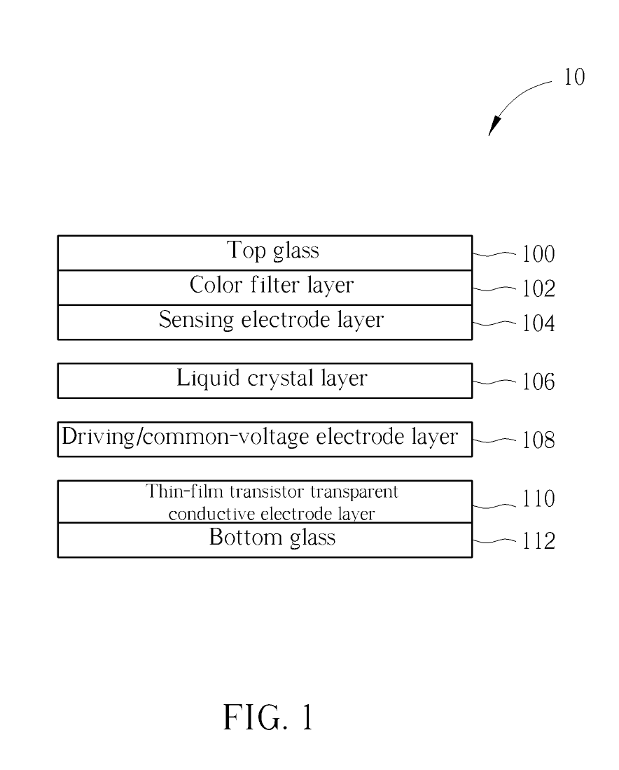

Please refer to FIG. 1, which is a structural diagram of an in-cell touch control panel 10 according to an embodiment of the present invention. As shown in FIG. 1, the in-cell touch control panel 10 includes a top glass 100, a color filter layer 102, a sensing electrode layer 104, a liquid crystal layer 106, a driving/common-voltage electrode layer 108, a thin-film transistor transparent conductive electrode layer 110 and a bottom glass 112. Transparent conductive electrodes in the thin-film transistor transparent conductive electrode layer 110 are mainly formed by Indium Tin Oxide (ITO), but may also be formed by micro (invisible to naked eyes) metal conductive lines.

In short, driving electrodes TX1-TXn are formed in the driving/common-voltage electrode layer 108 between the bottom glass 112 and the liquid crystal layer 106, and sensing electrodes RX₁-RXₘ are formed in the sensing electrode layer 104 between the top glass 100 and the liquid crystal layer 106, and are substantially perpendicular to the driving electrodes TX₁-TXₙ. The driving electrodes TX₁-TXₙ transmit driving signals in a time-domain scanning manner, and the sensing electrodes RX₁-RXₘ continuously obtain sensing signals and take a scanning sequence for positioning relative locations, so as to sense a touch point of the in-cell touch control panel 10. The operations of positioning the touch point are known to those skilled in the art, and are not narrated herein. As a result, the present invention may form the driving electrodes TX₁-TXₙ and the sensing electrodes RX₁-RXₘ on the bottom glass 112 and the top glass 100, respectively, and may effectively isolate the driving electrodes TX₁-TXₙ and the sensing electrodes RX₁-RXₘ by the liquid crystal layer 106 for simplifying the process.

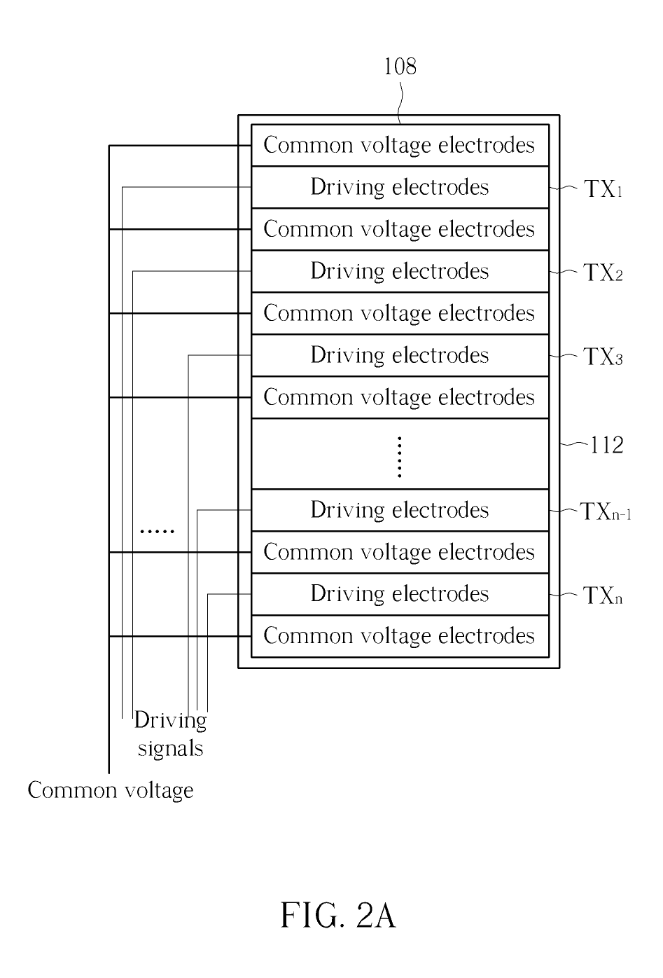

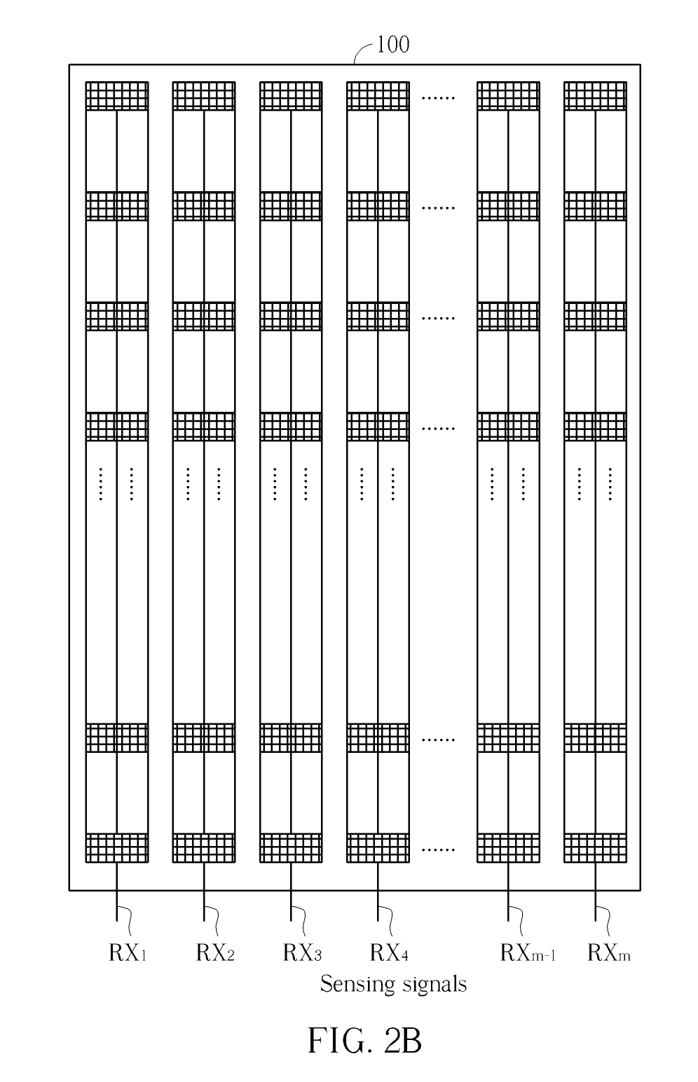

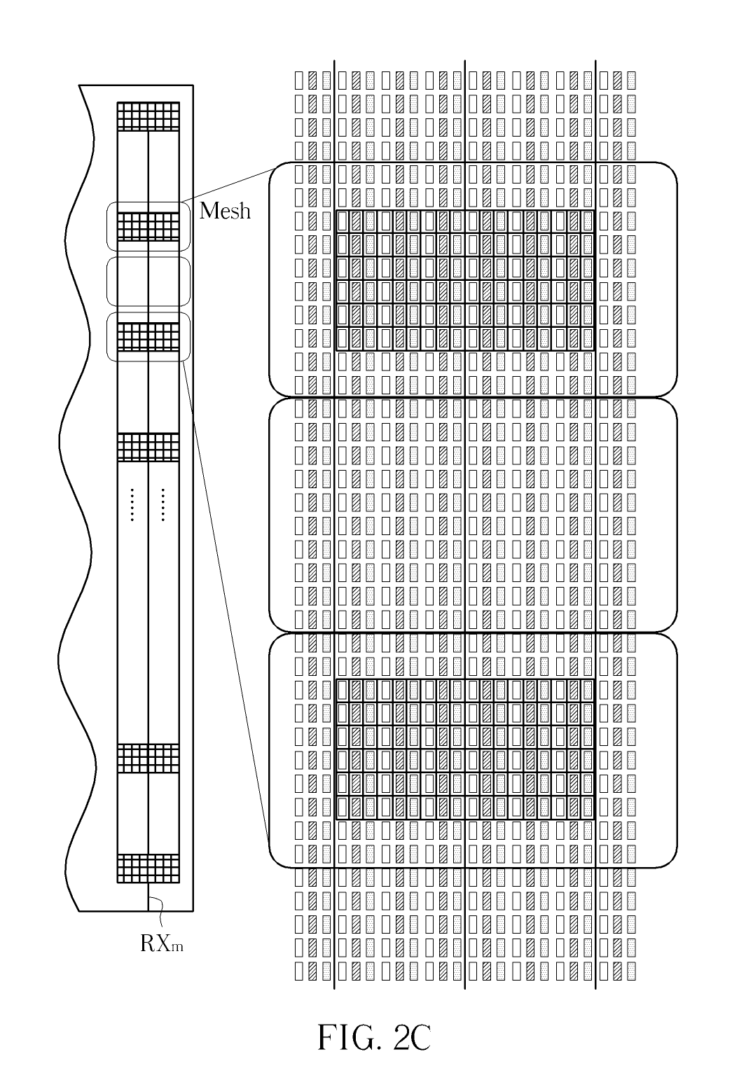

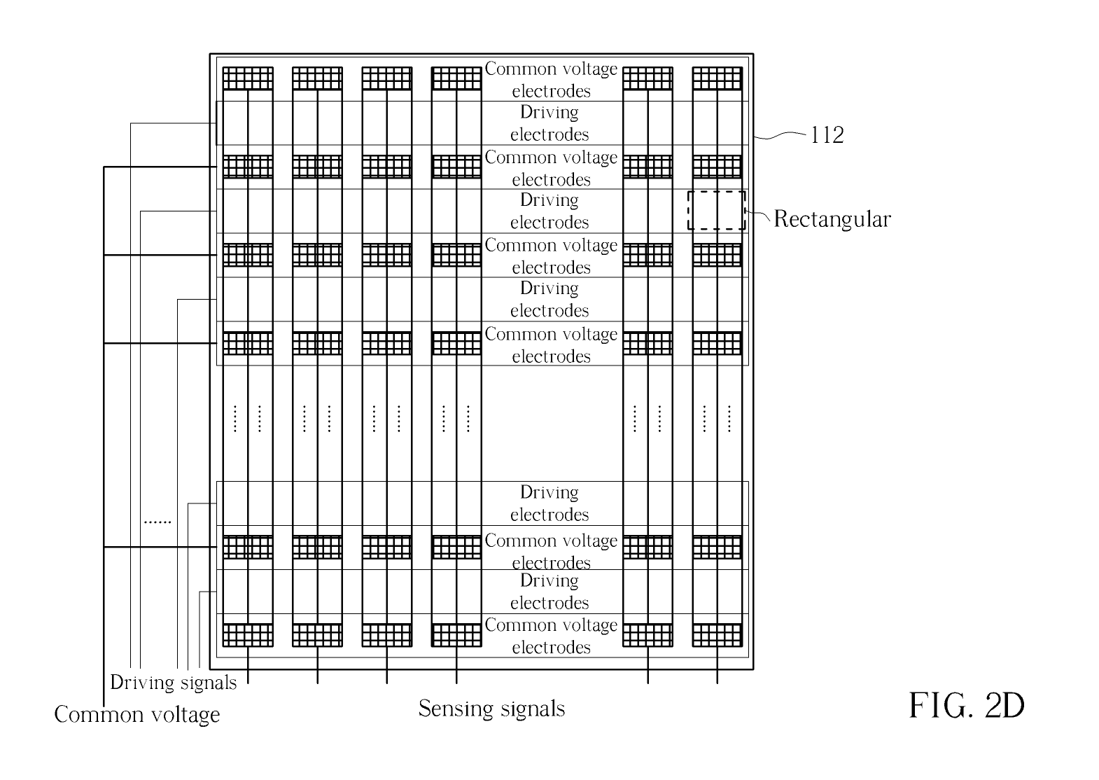

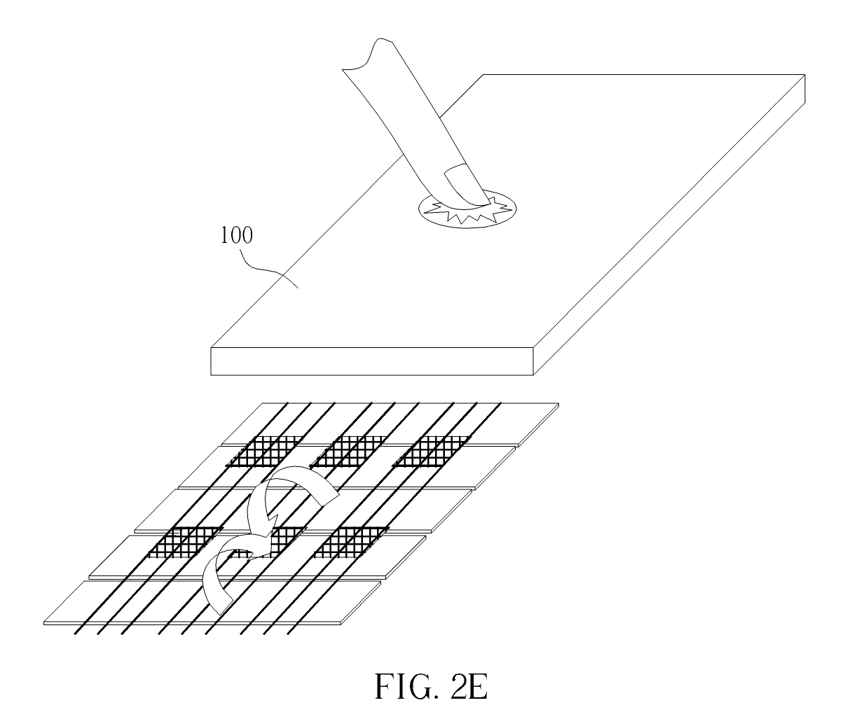

In detail, please refer to FIG. 2A, which is a schematic diagram of the driving/common-voltage electrode layer 108 according to an embodiment of the present invention. As shown in FIG. 2A, the driving electrodes TX₁-TXₙ are formed in the driving/common-voltage electrode layer 108 on the bottom glass 112, and are interlaced with the common voltage electrodes to form the driving/common-voltage electrode layer 108. In such structure, the driving electrodes TX₁-TXₙ transmit driving signals during a touch sensing period for positioning a touch point, and transmit a common voltage to a liquid crystal capacitor during a display period so as to cooperate with a display driving module for display (i.e. the driving electrodes TX₁-TXₙ are used as common voltage electrodes during the display period). As a result, compared to structures of non-in-cell touch control panels, the present invention only requires to layout the driving electrodes TX₁-TXₙ in the original common voltage electrode layer without additional processes when the driving electrodes TX₁-TXₙ are formed, and therefore simplifies the process.

On the other hand, please refer to FIG. 2B to FIG. 2E. FIG. 2B is a schematic diagram of the sensing electrode layer 104 according to an embodiment of the present invention, FIG. 2C is a perspective view of the sensing electrode layer 104 and pixels in the in-cell touch control panel 10 according to an embodiment of the present invention, FIG. 2D is a perspective view of the sensing electrode layer 104 and the driving/common-voltage electrode layer 108 in the in-cell touch control panel 10 according to an embodiment of the present invention, and FIG. 2E is a diagram of operations of the in-cell touch control panel 10 according to an embodiment of the present invention. As shown in FIG. 2B to FIG. 2D, the sensing electrodes RX₁-RXₘ are formed in a black matrix (BM) layer of the color filter layer 102 on the top glass 100. The sensing electrodes RX₁-RXₘ are not overlapped with the pixels of the in-cell touch control panel 10 underneath to avoid affecting display. For example, as shown in the right half part of FIG. 2C, the part of the sensing electrodes RX₁-RXₘ located above the pixels of the in-cell touch control panel 10 is formed as a mesh pattern. The sensing electrodes RX₁-RXₘ are not overlapped with the driving electrodes TX₁-TXₙ underneath, either, to avoid affecting touch point positioning due to overlap of electrodes. For example, as shown in the right half part of FIG. 2D, the part of the sensing electrodes RX₁-RXₘ located above the driving electrodes TX₁-TXₙ is formed as a rectangular pattern. In such a condition, as shown in FIG. 2E, the rectangular pattern can prevent overlap of electrodes, and the denser mesh pattern can increase sensitivity during touch point positioning. As a result, compared to structures of non-in-cell touch control panels, the present invention only requires forming the sensing electrodes RX₁-RXₘ between the top glass 100 and the liquid crystal layer 106 when forming the sensing electrodes RX₁-RXₘ, and thus the process is simplified.

Note that the above embodiments form the driving electrodes TX₁-TXₙ and the sensing electrodes RX₁-RXₘ on the bottom glass 112 and top glass 100, respectively, and effectively isolate the driving electrodes TX₁-TXₙ and the sensing electrodes RX₁-RXₘ by the liquid crystal layer 106 for simplifying the process. Those skilled in the art can make modifications and alterations accordingly. For example, in the above embodiments, the driving electrodes TX₁-TXₙ, which are interlacedly arranged with the common voltage electrodes, are laid out based on original common voltage electrodes when the driving electrodes TX₁-TXₙ are formed in order to simplify the process. In other embodiments, the driving electrodes TX₁-TXₙ may be formed as other patterns but are not limited to the rectangular pattern and the driving electrodes TX₁-TXₙ are also not limited to be interlaced with the common voltage electrodes. The driving electrodes TX₁-TXₙ may be formed on other part of the bottom glass 112 by an additional manufacturing step, as long as the driving electrodes TX₁-TXₙ and the sensing electrodes RX₁-RXₘ are effectively isolated by the liquid crystal layer 106 for simplifying the process.

Moreover, in the above embodiments, the sensing electrodes RX₁-RXₘ are formed in the BM layer of the color filter layer 102 on the top glass 100. The part of the sensing electrodes RX₁-RXₘ located above the pixels of the in-cell touch control panel 10 is formed as a mesh pattern so that the sensing electrodes RX₁-RXₘ are not overlapped with the pixels for preventing an impact on the display, and the sensing electrodes RX₁-RXₘ are not overlapped with the driving electrodes TX₁-TXₙ underneath to avoid affecting touch point positioning. However, in other embodiments, the sensing electrodes RX₁-RXₘ may be formed as other patterns, and may also be formed on other part of the top glass 100, as long as the driving electrodes TX₁-TXₙ and the sensing electrodes RX₁-RXₘ are effectively isolated by the liquid crystal layer 106 for simplifying the process.

In the prior art, since the driving electrodes and the sensing electrodes are both formed on the bottom glass in the conventional in-cell touch control panel, compared to structures of non-in-cell touch control panels, the conventional in-cell touch control panel requires more processes to isolate the driving electrodes and the sensing electrodes in order to prevent intersecting with each other, which leads to an impact on touch control determinations. In comparison, the present invention may form the driving electrodes TX₁-TXₙ and the sensing electrodes RX₁-RXₘ on the bottom glass 112 and the top glass 100, respectively, and may effectively isolate the driving electrodes TX₁-TXₙ and the sensing electrodes RX₁-RXₘ by the liquid crystal layer 106 for simplifying the process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An in-cell touch control panel, comprising:
a liquid crystal layer;
a top glass;
a bottom glass;
a plurality of driving electrodes, formed between the bottom glass and the liquid crystal layer; and
a plurality of sensing electrodes, formed between the top glass and the liquid crystal layer, and substantially perpendicular to the plurality of driving electrodes;
wherein the plurality of driving electrodes and the plurality of sensing electrodes are utilized for sensing a touch point on the in-cell touch control panel.

2. The in-cell touch control panel of claim 1, wherein the plurality of driving electrodes are formed in a driving/common-voltage electrode layer.

3. The in-cell touch control panel of claim 2, wherein the plurality of driving electrodes and a plurality of common voltage electrode layer are interlaced and formed in the driving/common-voltage electrode layer.

4. The in-cell touch control panel of claim 1, wherein the plurality of driving electrodes transmit a plurality of driving signals during a touch sensing period and transmit a common voltage during a display period.

5. The in-cell touch control panel of claim 1, wherein the plurality of sensing electrodes are formed in a black matrix (BM) layer.

6. The in-cell touch control panel of claim 5, wherein the plurality of sensing electrodes are not overlapped with a plurality of pixels of the in-cell touch control panel underneath.

7. The in-cell touch control panel of claim 6, wherein a part of the plurality of sensing electrodes located above the plurality of pixels of the in-cell touch control panel is formed as a mesh pattern.

8. The in-cell touch control panel of claim 5, wherein the plurality of sensing electrodes are not overlapped with the plurality of driving electrodes underneath.

9. The in-cell touch control panel of claim 8, wherein a part of the plurality of sensing electrodes located above the plurality of driving electrodes is formed as a rectangular pattern.
